(19) United States
(12) Patent Application Publication
(10) Pub. No.: US 2002/0199111 A1
(43) Pub. Date: Dec. 26, 2002

(54) Methods and apparatus for preventing reverse-engineering of integrated circuits

(76) Inventors: Dereck B. Clark, Glendale, AZ (US); Lawrence Gorton, Henderson, NV (US)

Correspondence Address: Daniel R. Pote, Esq., SNELL & WILMER L.L.C., One Arizona Center, 400 East Van Buren, Phoenix, AZ, 85004-2202, US

(21) Appl. No.: 10/080,280

(22) Filed: Feb. 19, 2002

Related U.S. Application Data
(60) Provisional application No. 60/269,312, filed on Feb. 16, 2001.

(51) Int. Cl. G06F 12/14

(52) U.S. Cl. 713/194

(57) ABSTRACT

A structure is configured to inhibit reverse-engineering of an integrated circuit by creating a protective “cocoon” around the IC and associated circuits. The cocoon material is, in one embodiment, designed such that if it is tampered with, one or more electrical device parameters (e.g. capacitance, resistance, etc.) of the cocoon will change, and the IC will detect the changes and act accordingly, e.g., by destroying the valuable encryption keys, programs, or other information that is being protected under or near the cocoon material.

### CROSS-REFERENCE TO RELATED APPLICATIONS

This application claims priority from Provisional Patent Application Ser. No. 60/269,312 filed Feb. 16, 2001.

### BACKGROUND

1. Technical Field

The present invention relates, generally, to integrated circuit devices and, more particularly, to methods for preventing reverse-engineering of integrated circuit devices to protect confidential information stored and/or imbedded therein.

2. Background Information

Companies often invest a tremendous amount of resources to research and develop sophisticated integrated circuits for use in their products, only to discover later that a competitor has effectively reversed-engineered their integrated circuit (IC) design. Furthermore, some electronic products and associated ICs are used to encrypt sensitive authentication data, e.g. Personal Identification Numbers (PINs), Credit Card Numbers, Biometric Characteristics (iris scans, fingerprints, voice prints, etc.), and the like. There is thus a critical need to protect these ICs from attacks by individuals who attempt to reverse engineer the design of the electrical circuits and/or the contents of the memory, which may include encryption keys, algorithms, and programs used to protect the encryption keys.

There have been a number of attempts to solve the problem of reverse engineering of ICs and associated circuitry. Such schemes are unsatisfactory in a number of respects. For example, placing encapsulation material over ICs and associated circuitry may offer some degree of protection; however, attackers can use various acid and solvent formulations to attack the encapsulation material to gain access to the valuable circuits and contents of the memory trying to be protected.

Physical interlocks that can detect tampering also offer some degree of protection for confidential data, and various levels of interlocks may add confusion to an attacker. However, with enough time and resources a sophisticated attacker can usually circumvent interlocks that are used to detect tampering of the IC and associated package.

More advanced techniques utilized to protect ICs include placing an opaque coating over the IC that adheres to the top metal layer of an IC. In the event the opaque coating is removed, the coating has a tendency to also remove some of the metal contacts and traces on the top surface of the IC, making it very difficult to reverse engineer the remaining IC.

Another method that has been used to protect ICs from reverse engineering involves placing a conductive mesh over the circuit to be protected and tying it to a monitoring circuit that detects whether an individual and/or machine is tampering with the IC. If the conductive mesh is tampered with, and the associated monitoring circuit detects such tampering, the IC can then destroy the confidential data.

Other methods include attempts to cause confusion for the individual trying to reverse engineer the chip or device. Such methods include, for example, placing phantom silicon layers or circuits to the IC that really have no function other than to confuse an attacker. These and other prior art solutions have a number of disadvantages as they are expensive, and attackers can usually circumvent the protection solutions given enough time and resources.

There is a long-felt need to solve this problem, as more and more individuals and companies are utilizing electronic products that require a very high degree of security in protecting confidential circuits, encryption keys, and the embedded program that uses the encryption keys to protect one's identity for use in Internet commerce and other remote authentication markets.

### DESCRIPTION OF THE DRAWINGS

FIG. 1 is a schematic overview of an IC cocoon in accordance with the present invention;

FIG. 2 is a more detailed schematic of an IC cocoon in accordance with the present invention;

FIG. 3 is a schematic showing another embodiment of the present invention; and

FIGS. 4(a)-4(c) show the time response of an exemplary system responding to a pulse input; and

FIG. 5 shows exemplary cocoons in accordance with the present invention.

### DETAILED DESCRIPTION

The present invention overcomes the weaknesses of the prior art by providing a structure configured to inhibit reverse-engineering of an integrated circuit by creating a protective “cocoon” around the IC and associated circuits. The cocoon material is, in one embodiment, designed such that if it is tampered with, one or more electrical device parameters (e.g. capacitance, resistance, etc.) of the cocoon will change, and the IC will detect the changes and act accordingly, e.g., by destroying the valuable encryption keys, programs, or other information that is being protected under or near the cocoon material.

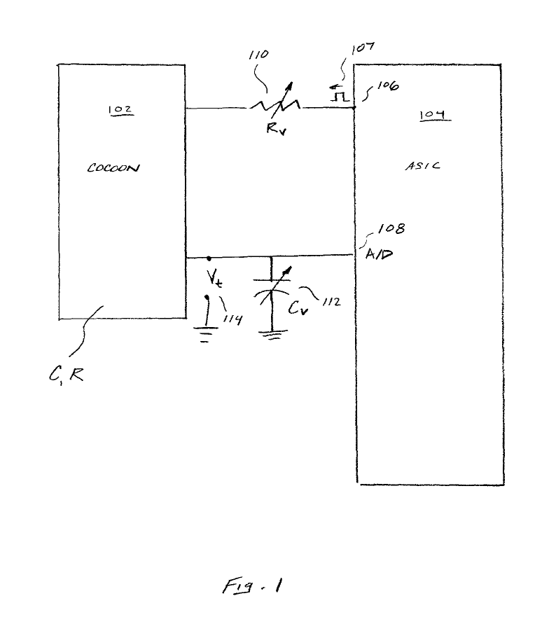

Referring now to FIG. 1, a cocoon 102 comprises a material having an embedded capacitance C and resistance R dispersed throughout the material of cocoon 102 in a manner whereby it is substantially impossible to penetrate cocoon 102 mechanically without changing the C and/or the R value of the cocoon material. The capacitance is preferably relatively small in value such that the anticipated change in the cocoon material after attack will be due primarily to the change in the resistance.

The cocoon material is wrapped around or otherwise encapsulates the IC to be protected, and electrical leads and/or wires exit the cocoon 102 to connect to the printed circuit board (PCB) or other component, e.g., integrated circuit (IC) 104 (e.g., an Application Specific Integrated Circuit, or “ASIC”) which is configured to monitor the state of cocoon 102 and perform a predefined action (e.g., destructions of keys, etc.) in response to a change in the state of cocoon 102.

The exemplary cocoon capacitor and resistor material is connected to IC 104 in a circuit as illustrated. Utilizing the exemplary circuit, a variable pulse (i.e., variable voltage, amplitude, and/or pulse width) is generated at output 106 of IC 104 and is applied to cocoon 102 such that the voltage 114 (Vt) charges and discharges based on the following formula:

Vt=V₀e^{-t/RC}

Where V_{O} is the amplitude of the pulse. Vt is suitably monitored by IC 104 at input 108, e.g., through the use of an integral analog-to-digital converter. A variable resistor 110 and/or variable capacitor 112 may also be employed to more finely tune the response of Vt.

In accordance with one embodiment of the present invention, upon initialization of the product (including the chip being protected, not shown), the IC sends a pulse to cocoon 102, and after a predetermined time, the voltage Vt response is measured (or a number of high frequency pulses recorded for a given time), and the value of the RC time constant is established and recorded in the non-volatile memory of IC 104 for future comparison. The initialization process may include various algorithms and levels of filtering associated with recording the initial Vt (or the transformation of Vt into equivalent high frequency pulses for potentially more accurate equivalent measurements of Vt) to obtain a representative Vt for the particular cocoon 102 being analyzed.

A number of pulses of various pulse lengths starting at various times and even with various amplitudes may be applied to cocoon 102 to provide a wide range of voltage (Vt) measurements at a given time from the start of the pulse being sent to the cocoon material. In this manner it would be difficult for an attacker to circumvent the security solution offered by the present invention.

Furthermore, the resistance and capacitance provided by cocoon 102 may be selected by incorporating more than one material into cocoon 102. The value of capacitance C may be varied by changing the size the capacitor plates (i.e., plates integrated into the matrix of the material used for cocoon 102), distance between the capacitor plates, and the value of the dielectric between the capacitor plates, thus providing various characteristics for the cocoon material.

Additionally, as described above, an external variable capacitor 112 may be placed under the cocoon material in parallel with the cocoon capacitor, thus offering a wider range of variability in the cocoon circuit. In a similar manner, an external variable resistor 110 may be attached in series with the resistor that forms a part of the cocoon material to also offer a wider range of resistance variability to the cocoon 102. Both the variable resistor 110 and variable capacitor 112 may be randomly adjusted during manufacturing and prior to the initialization process. The intent of the cocoon 102 and associated circuitry is to offer a unique protective layer over the chip to be protected; therefore, prevent an attacker from successfully reverse engineering one cocoon circuit and determining its characteristics (e.g. pulse width, time to measure Vt, etc.) and attempting to then apply this knowledge in an attack on a second cocoon circuit.

In addition, the chip to be protected may itself have variable internal resistors that form a part of the chip, and can be systematically or randomly created during the initialization process using, for example, fusible link technology via a “scan chain” or other like methods. Similarly, internal capacitors in the chip can be created via fusible links techniques that are systematically or randomly created during initialization of the product. Internal capacitors would typically be very small in value (20 to 50 pF) and therefore offer little variation. An attacker that studies the electromagnetic wave emissions from the cocoon material would not likely be able to determine how much resistance and capacitance is due to the cocoon material and how much is due to the external components and internal resistance and capacitance, therefore making it difficult to replace the cocoon material based on previously studied cocoon material and variable resistors and capacitors.

In accordance with another embodiment of the present invention, a circuit is provided for measuring the time of an integrator circuit to provide a higher degree of accuracy and repeatability in measuring the characteristics of the RC circuit. At a predetermined time, a counter starts counting to measure the voltage at the capacitor. One embodiment of the invention contains the necessary control circuitry and program within the IC to be protected while another embodiment utilizes an external microcontroller or other similar dedicated circuitry working in conjunction with the IC to be protected.

The pulse 107 applied across the cocoon circuit 102 results in a charging of the capacitor, and then a decay of the charge begins after the pulse voltage is reduced back towards a ground reference. At a predetermined time (which may stored within IC 104), a measurement of the Vt voltage 114 at the output of the cocoon 102 is conducted by IC 104 via an analog to digital (A/D) circuit 108 that forms a part of IC 104. The Vt measurement is compared against a table of data previously recorded during the aforementioned initialization process. If the measured Vt is within acceptable limits recorded and/or determined during the initialization process, then it is very unlikely the cocoon circuit is under attack. However, if it is determined that the Vt measurement falls outside the established acceptable limits for the given cocoon circuit and pulse applied to the cocoon circuit, then an attack is assumed and the appropriate actions will be taken. The actions may include, for example, destroying encryption keys and program parameters stored in volatile memory that may be valuable to an attacker.

Additional layers of complexity, hence confusion to an attacker, may be added to the present embodiment by varying pulse initiation, varying the pulse duration, pulse amplitude, and pulse measurement time to when the Vt is measured at the output of the cocoon material.

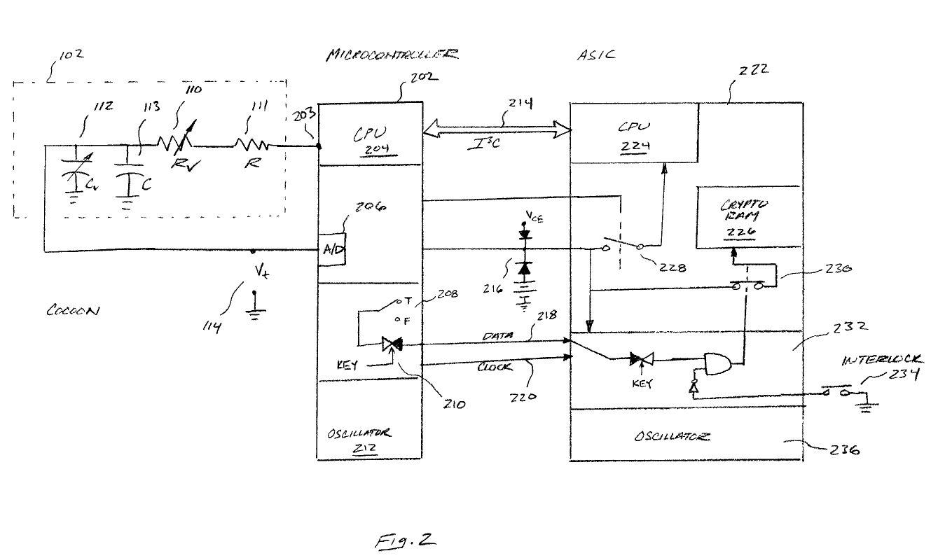

Referring now to FIG. 2, in another embodiment of the invention, an external microcontroller 202 is attached to the chip to be protected. The external microcontroller 202 and the chip being protected are encapsulated or otherwise protected by the cocoon material. External microcontroller 202 is used in a similar manner as presented in the first embodiment. However, the external microcontroller communicates with the chip to be protected whether the cocoon circuit is under attack or not. The benefit of the external microcontroller embodiment is that microcontroller 202 can also control power to the chip being protected for improved power management, and can give a developer of ASIC 222 time to focus on design of their ASIC without having to worry about the details of the cocoon circuit 102 and control of the cocoon circuit. The external microcontroller 202 presented in this example contains an internal oscillator 212, CPU 204, A/D converter 206, Key tester 210 and 208, and various regions for RAM, ROM and/or EEPROM to store the program memory of the external microcontroller. The external microcontroller is provided power via a battery 216 which is also preferably disposed beneath or within the cocoon material, thereby preventing tampering with the power supply. IC (or ASIC) 222 comprises a CPU 224, crypto RAM 226 (for storing, inter alia, cryptographic information), interlock 230, Key tester 232, oscillator 236, and interlock 234.

The external microcontroller 202 provides, among other things, monitoring of the cocoon circuit 102 as presented in the first embodiment. External microcontroller 202 also preferably controls standby power used by the ASIC 222 (in this example) for various purposes, including additional security check monitoring. If standby power was to be provided all the time to all the standby power ASIC circuits, the standby power battery might become prohibitive in cost and size. Therefore, the external microcontroller 202 can “wake up” the ASIC 222 if it determines that the cocoon circuit 102 is under attack, at incremental time intervals, or even randomly, in order to further confuse an attacker that may be trying to monitor the cocoon circuit via non-invasive electromagnetic emission techniques. Furthermore, the external microcontroller embodiment as shown might become a standard mechanism for protecting circuits under the cocoon material; therefore, it becomes a more general solution to the first embodiment.

Between the external microcontroller 202 and the ASIC 222 is preferably a communication I³C bus 214. The data communicated between the external microcontroller 202 and the ASIC 222 is preferably encrypted. If the ASIC 222 receives an indication from the external microcontroller 202 that the cocoon circuit 102 is under attack, the ASIC 222 may take appropriate measures to destroy the contents of critical data (e.g. encryption keys, critical program parameters, etc.) in a manner similar to the first embodiment.

Variations in the above embodiments are anticipated which can enhance the value of the present invention. Additionally, it is desired to create a solution to minimize the risk of reverse engineering a ASIC (or IC) and associated circuitry while not placing a huge burden on the manufacturing process and associated production costs. The present embodiments provide a low cost solution that can provide a very high degree of protection from reverse engineering an IC and associated circuit.

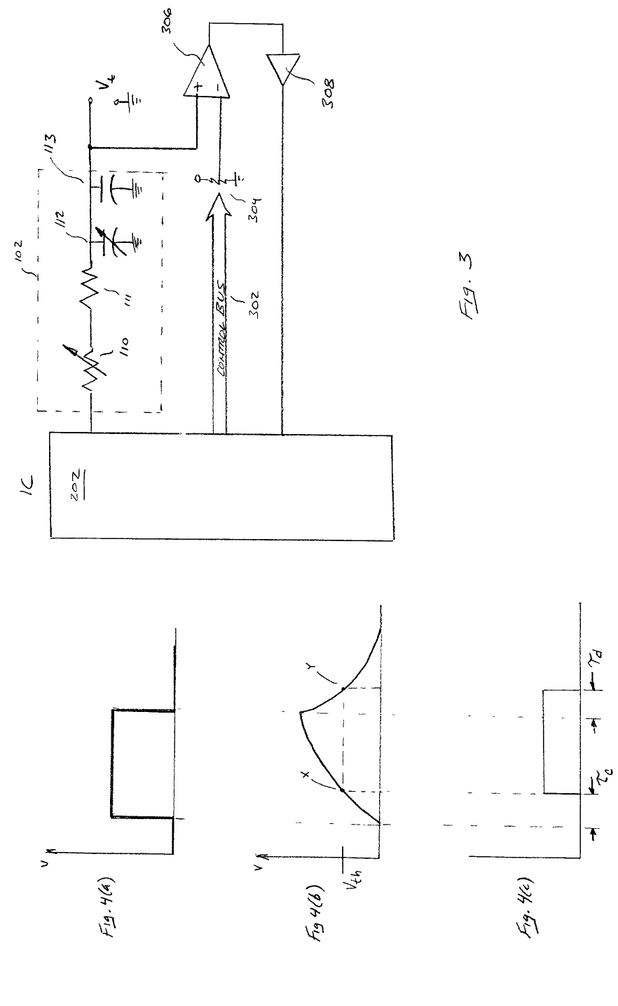

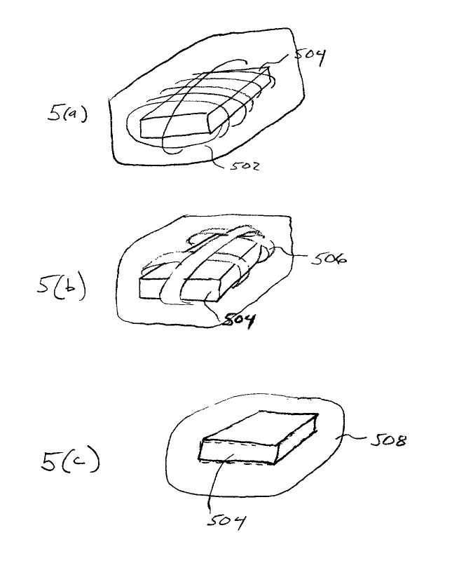

Yet another embodiment of the present invention includes measuring the voltage across the cocoon material by transforming the voltage (Vt) across the cocoon capacitor into a measurement of the charging time and discharging time. FIG. 3 presents a representation of this embodiment for a measurement circuit. Additionally, FIGS. 4(a)-(c) present the typical input pulse and output responses relevant to its operation. The pulse (FIG. 4(a)) is illustrated as a square wave; however, the pulse could be any shape, e.g., triangular or rectified sinusoidal, to add further variation to the signal being applied to the cocoon material. The signal could be a combination of the various waveform shapes or a combination of waveforms sequences (e.g. two square waveforms, then three triangular waveforms, etc.). The present invention comprehends any individual or combination of waveforms shapes.

The output of the cocoon material (Vt) is supplied to a comparator circuit 306 that has a fixed or variable threshold input. The variable threshold input could be controlled by a manual potentiometer (adjusted at the production factory) or a microprocessor-controlled potentiometer 304 (controlled via control bus 302) to offer more variability of the “trigger point” of the comparator. Any other convenient method of varying this parameter may be used. When the “trigger point” or the threshold (e.g. 2.5 volts) is reached, the comparator 306 sends a low-to-high voltage interrupt signal to the microcontroller via an optional Schmitt trigger 308. The microcontroller 202 (or microprocessor, or CPU) will use the interrupt information to start a timer or stop a timer to measure the charging time and discharging time of the cocoon RC circuit.

With continued reference to FIGS. 3 and 4, the charging time (τ_{c}) is the time from the beginning of the pulse (e.g. the transition from low-level signal to high-level signal) being supplied from the IC 202 to the point where the “trigger level” of the comparator is reached (point x in the timing diagram of FIG. 4(b)). In contrast, the discharging time (τ_{d}) is presented in FIG. 4 as the time from when the pulse from the IC 202 ends (e.g. the transition from high-level signal to low-level signal) until the voltage (Vt) reaches the “trigger level” or “threshold level” (Vth) at the comparator 306 (point y in the timing diagram of FIG. 4(b)). To improve noise immunity of the comparator input circuit, a hysteresis circuit could be added to the comparator or a Schmitt Trigger device 308 (e.g. a standard 74HC14 component) could be interposed between the output of the comparator 306 and the interrupt input of the IC 202.

The IC 202 suitably records the charging time (τ_{c}) and discharging time (τ_{d}) upon the initialization of the circuit to be protected. The recorded information can then be used to determine if the cocoon material is being tampered with so that the IC can take appropriate action. The initialization information could even be recorded across various ambient temperatures to produce a table of τ_{c} and τ_{d} that is a function of ambient temperature to prevent potential false alerts due to temperature excursions.

The measurement technique described in connection with FIGS. 3 and 4 offers the ability to change the setting of the comparator “trigger level” dynamically if a digitally-controller potentiometer 304 is utilized in the circuit. This flexibility to change the “trigger level” of the comparator gives one more degree of freedom with respect to the number of parameter combinations. The more combinations of parameters that can be varied (e.g. pulse width, pulse amplitude, pulse duration, pulse duty cycle, trigger level of comparator, cocoon material (R, C, Rv, Cv), etc.), the more difficult it will be for a hacker to circumvent the protective layer of the cocoon material and determine the contents of the chip being protected by the cocoon.

Referring now to FIG. 5, the cocoon itself may take a variety of forms. For example, the cocoon may comprise a single “thread” 502 of material wrapped or otherwise configured to surround the chip 504 (FIG. 5(a)). The cocoon may also include a “ribbon” of material 506 wrapped around the chip 504 in any convenient manner (FIG. 5(b)). The cocoon may also consist of a bulk material 508 (e.g., customized polymer, or the like) which surrounds or forms a mold around the chip 504. In addition, any combination of these embodiments may be employed. For the purpose of simplicity, the various leads that would typically interface to the cocoon have not been shown.

Referring again to FIGS. 3 and 4, the digitally-controlled potentiometer might also be varied to change the “trigger” level of the comparator (point x and y). The trigger level may be set to a variety of suitable levels (e.g. 2.5 volts, 3.7 volts, etc.) for a give pulse provided by the IC 202 as previously described. In addition, via the digitally-controlled potentiometer 304, the trigger level may be varied after the transition of the pulse from a high-level to low-level signal. For example, in case 1, the trigger level might be, for example, 2.4 volts for determining the charge time (point x) and, for example, 4.1 volts for determining the discharge time (point y). In case 2, the trigger level is 3.9 volts to determine the charge time (point x) and trigger level is 1.7 volts to determine the discharge time (point y). This offers yet another variable beyond setting the “trigger level” of the comparator to only one value for a given pulse provided by the microcontroller. Furthermore, the initialization routine might record a number of “trigger-level cases” for setting the trigger level for the charge time and discharge time point. The microcontroller could later randomly or systematically choose the particular trigger level case to set the trigger level for comparison with the initialization recorded data to determine if the cocoon material in under attack by a hacker.

Although the invention has been described herein in conjunction with the appended drawings, those skilled in the art will appreciate that the scope of the invention is not so limited. Modifications in the selection, design and arrangement of the various components and steps discussed herein may be made without departing from the scope of the claimed invention.

We claim:

1. A system for preventing reverse-engineering of a device, said system comprising:
a cocoon surrounding at least a portion of said device, said cocoon being characterized by a set of electrical characteristics, wherein at least one of said electrical characteristics changes in result to mechanical manipulation of said cocoon;
an integrated circuit configured to send an input signal to said cocoon and receive a response signal from said cocoon, wherein said response signal is responsive to said change in said at least one electrical characteristic of said cocoon; said integrated circuit further configured to take a predetermined action in the event that said response signal is indicative of said mechanical manipulation.

2. The system of claim 1, wherein said set of electrical characteristics includes capacitance.

3. The system of claim 1, wherein said set of electrical characteristics includes resistance.

4. The system of claim 1, further including an external variable resistor.

5. The system of claim 1, further including an external variable capacitor.

6. The system of claim 1, wherein said cocoon comprises a bulk material, and wherein said electrical characteristics correspond to electrical characteristics of said bulk material.

7. The system of claim 1, wherein said cocoon comprises a wire wrapped around a portion of said device.

8. The system of claim 1, wherein aid cocoon comprises a matrix of conductive material surrounding a portion of said device.

9. The system of claim 1, wherein said cocoon comprises a ribbon wrapped around a portion of said device.

10. The system of claim 1, wherein said cocoon comprises an epoxy.

11. The system of claim 1, further comprising a microprocessor interposed between said cocoon and said integrated circuit.

12. The system of claim 1, wherein said input signal comprises a step input, and wherein said response signal is a first-order step response of said cocoon to said step input.
